(19) United States
(12) Patent Application Publication
(10) Pub. No.: US 2023/0163288 A1
(43) Pub. Date: May 25, 2023

(54) Method for Producing Lithium Oxide Coated with Carbon and Lithium Oxide Coated with Carbon

(71) Applicant: Nippon Telegraph and Telephone Corporation, Tokyo (JP)

(72) Inventors: Akihiro Kono, Musashino-shi, Tokyo (JP); Hironobu Minowa, Musashino-shi, Tokyo (JP); Masaya Nohara, Musashino-shi, Tokyo (JP); Takeshi Komatsu, Musashino-shi, Tokyo (JP)

(21) Appl. No.: 17/922,272

(22) PCT Filed: May 21, 2020
(86) PCT No.: PCT/JP2020/020149

§ 371 Date: Oct. 28, 2022

(51) Int. Cl. H01M 4/48; H01M 10/0525; H01M 4/62

(52) U.S. Cl. CPC H01M 4/483; H01M 10/0525; H01M 4/625

(57) ABSTRACT

A lithium oxide coated with carbon, wherein the carbon contains co-continuous fibrous carbon having a three-dimensional network structure in which carbon is branched.

### TECHNICAL FIELD

The present invention relates to a method for producing a carbon-coated lithium oxide, and to a carbon-coated lithium oxide.

### BACKGROUND ART

Lithium-ion secondary batteries that rely on lithium-ion intercalation and deintercalation reactions are widely used as secondary batteries of high energy density, in various electronic devices, automotive power sources, power storage and the like. There is ongoing research and development being devoted to electrode materials and electrolyte materials, with a view to enhancing performance and reducing costs (NPL 1).

Lithium ion secondary batteries have recently attracted attention as mobile power sources in the wake of the development of IT devices such as smartphones and IoT devices. A smaller size of the mobile devices entails a need for smaller and thinner batteries, and thus a need for battery materials that exhibit ever higher energy densities.

### CITATION LIST

### Non Patent Literature

[NPL 1] Takanori MAHARA et al., “Enhancement in Cyclic Life Performance and Discharge Capacity of Li₂CoPO₄F by Optimization of Synthesis Method and Carbon Coating Process”, GS Yuasa Technical Report, Vol. 14 No. 1, Jun. 28, 2017
Nature Vol. 363 603-605 (1993)
[NPL 3] Chemical Physics Letters Vol. 292 567-574 (1998)

### SUMMARY OF THE INVENTION

### Technical Problem

In NPL 1 attention is given to Li₂CoPO₄F which is a polyanionic positive electrode active material, as an example of a battery of high voltage and high energy density. Herein Li₂CoPO₄F has two Li atoms per composition formula, and hence has a higher theoretical capacity (287 mgAh/g).

Herein Li₂CoPO₄F has low ionic conductivity and accordingly needs to be imparted with electron conductivity for instance through application of a carbon coating, in order to be used as a positive electrode active material. Carbon nanotubes, fullerenes, graphene, graphite and amorphous carbon are used as carbon for imparting electron conductivity.

With spherical or scaly fullerenes, graphene, graphite and amorphous carbon it is difficult to maintain electrical conductive paths between pieces of positive electrode active material, and large amounts of carbon are required in order to elicit a desired conductivity; the amount of the positive electrode active material decreases relatively as a result, which translates into lower energy density.

Fibrous carbon nanotubes can be expected to exhibit high conductivity based on their unique structure; preferably, however, a positive electrode active material is uniformly coated with the carbon nanotubes, without aggregation of these, with a view to effectively bring out the characteristic of such a fibrous form. Ordinary carbon nanotubes, however, have strong cohesive forces and form fascicular aggregates called bundles, which makes it difficult to uniformly coat a positive electrode active material with carbon nanotubes.

Various attempts have been made to improve the dispersibility of carbon nanotubes in dispersion media. Examples include an ultrasound irradiation method (NPL 1). In this ultrasound irradiation method, though, aggregation of carbon nanotubes restarts once irradiation with ultrasounds is over. Known methods for producing carbon nanotubes include for instance electrode discharge, vapor phase epitaxy and laser methods (NPL 2 and 3).

Therefore, obtaining lithium oxide coated with highly conductive carbon is an important issue in terms of producing batteries of high energy density.

It is an object of the present invention, arrived at in the light of the above considerations, to provide a carbon-coated lithium oxide of high conductivity, and to provide a method for producing that carbon-coated lithium oxide.

### Means for Solving the Problem

A carbon-coated lithium oxide in one aspect of the present invention is a lithium oxide coated with carbon, wherein the carbon contains co-continuous fibrous carbon having a three-dimensional network structure in which carbon is branched.

One aspect of the present invention is a method for producing a carbon-coated lithium oxide, the method including a pulverization step of pulverizing co-continuous fibrous carbon having a three-dimensional network structure in which carbon is branched; and a mixing step of mixing the pulverized co-continuous fibrous carbon and a lithium oxide.

### Effects of the Invention

The present invention allows providing a carbon-coated lithium oxide of high conductivity, and a method for producing the carbon-coated lithium oxide.

### BRIEF DESCRIPTION OF DRAWINGS

FIG. 1 is a flowchart illustrating a method for producing co-continuous fibrous carbon according to an embodiment of the present invention.

FIG. 2 is an SEM image of co-continuous fibrous carbon.

FIG. 3 is a flowchart illustrating a method for producing a carbon-coated lithium oxide according to an embodiment of the present invention.

### DESCRIPTION OF EMBODIMENTS

Embodiments of the present invention will be explained next with reference to accompanying drawings.

### Production Method of an Embodiment

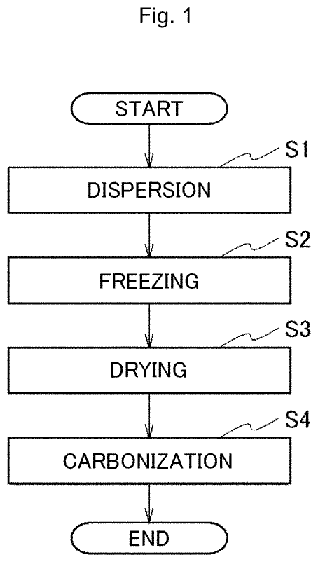

FIG. 1 is a flowchart illustrating a method for producing co-continuous fibrous carbon according to an embodiment of the present invention.

The method for producing co-continuous fibrous carbon of the present embodiment includes a dispersion step (step S1), a freezing step (step S2), a drying step (step S3), and a carbonization step (step S4). This production method requires a cellulose nanofiber dispersion.

The starting material is not particularly limited so long as it is cellulose nanofibers. Cellulose nanofibers include for instance wood-derived, pulp-derived, crustacean-derived, bacteria-derived, food-derived, plant-derived cellulose nanofibers, and other cellulose nanofibers of biological origin. As the cellulose nanofibers there may be used at least one type selected from the group consisting of wood-derived cellulose nanofibers, pulp-derived cellulose nanofibers, crustacean-derived cellulose nanofibers, bacteria-derived cellulose nanofibers, food-derived cellulose nanofibers, plant-derived cellulose nanofibers and other cellulose nanofibers of biological origin.

The form of the cellulose nanofibers in the cellulose nanofiber dispersion is preferably a dispersed form. Therefore, the production process illustrated in FIG. 1 includes a dispersion step (step S1), but the dispersion step (step S1) need not to be included. That is, the above step is not necessary in a case where a dispersion is used that has cellulose nanofibers dispersed therein.

In the dispersion step the cellulose nanofibers contained in the cellulose nanofiber dispersion are dispersed. The dispersion medium includes at least one type selected from the group consisting of aqueous dispersion media such as water (H₂O), and organic dispersion media such as carboxylic acids, methanol (CH₃OH), ethanol (C₂H₅OH), propanol (C₃H₇OH), n-butanol, isobutanol, n-butylamine, dodecane, unsaturated fatty acids, ethylene glycol, heptane, hexadecane, isoamyl alcohol, octanol, isopropanol, acetone and glycerin. The dispersion medium may be made up of at least one type selected from among the above group.

The cellulose nanofibers may be dispersed using for instance a homogenizer, an ultrasonic cleaner, an ultrasonic homogenizer, a magnetic stirrer, a stirrer or a shaker.

The solids concentration of the cellulose nanofibers in the cellulose nanofiber dispersion is preferably from 0.001 to 80 mass %, more preferably from 0.01 to 30 mass %. This is because when the solids concentration is excessively low, a network between cellulose nanofibers cannot be formed and it becomes difficult to form a carbon co-continuous structure in the below-described carbonization step (step S4). When the solids concentration is too high, aggregation occurs in the freezing step (step S2) described below, and also cellulose sintering progresses in the carbonization step (step S4), which makes it difficult to form a fibrous structure.

In the freezing step the cellulose nanofiber dispersion is frozen, to yield a frozen product (step S2). This step can be carried out for instance by accommodating the cellulose nanofiber dispersion in an appropriate container such as a test tube, and cooling the periphery of the test tube in a cooling material such as liquid nitrogen, to freeze as a result the cellulose nanofibers accommodated in the test tube.

The method for elicit freezing is not particularly limited, so long as the dispersion medium of the cellulose nanofiber dispersion can be cooled down to or below the freezing point, and may involve cooling in a freezer or the like. Through freezing of the cellulose nanofiber dispersion, the dispersion medium loses flowability and the cellulose nanofibers, which are dispersoids, become fixed, to construct thus a three-dimensional network structure.

In the drying step the frozen product having been frozen in the freezing step is dried in vacuum, to yield a dry product (step S3). In this step the frozen dispersion medium is caused to sublimate from the solid state. To carry out this step, for instance the obtained frozen product is placed in an appropriate container such as a flask, and the interior of the container is evacuated. By placing the frozen product in a vacuum atmosphere, the sublimation point of the dispersion medium drops, and it becomes possible to sublimate also a substance that does not sublimate under normal pressure.

The degree of vacuum in the drying step varies depending on the dispersion medium that is used, and is not particularly limited so long as it is a degree of vacuum such that the dispersion medium sublimates. In a case where water is used as the dispersion medium, it is necessary to set the pressure to a degree of vacuum of 0.06 MPa or less; however, drying takes some time herein on account the heat that is robbed in the form of latent heat of sublimation. Therefore, the degree of vacuum is preferably from 1.0×10⁻⁶ Pa to 1.0×10⁻² Pa. Heat may be applied, using a heater or the like, at the time of drying.

In the carbonization step, the dry product having been dried in the drying step is carbonized by being heated in an atmosphere in which the dry product is not burned, to yield co-continuous fibrous carbon (step S4). Carbonization of cellulose nanofibers may be accomplished by firing at from 200° C. to 2000° C., more preferably from 600° C. to 1800° C., in an inert gas atmosphere. The gas in which cellulose does not burn may be for instance an inert gas such as nitrogen gas or argon gas. Further, the gas in which cellulose does not burn may be a reducing gas such as hydrogen gas or carbon monoxide gas, or may be carbon dioxide gas. More preferable herein is carbon dioxide gas or carbon monoxide gas, having an activating effect on carbon materials and which can be expected to afford high activation.

Co-continuous fibrous carbon having a three-dimensional network structure is obtained in accordance with the production method described above.

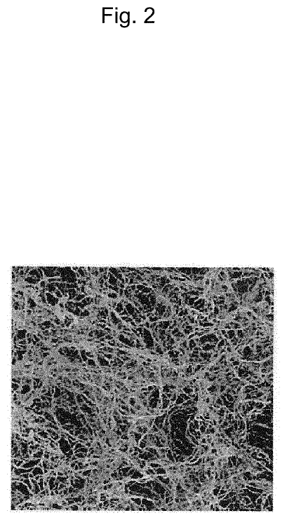

FIG. 2 is a SEM (Scanning Electron Microscope) image of co-continuous fibrous carbon produced in accordance with the production method of the present embodiment. The magnification is 10000 times. The image reveals the fashion in which a three-dimensional network structure is constructed.

As described above, the co-continuous fibrous carbon of the present embodiment has a three-dimensional network structure in which fibrous carbon is branched and in which co-continuous is rendered, unlike that of the carbon nanotubes in which aggregates are formed. Therefore, even when this co-continuous fibrous carbon is added as a conductive filler to a solvent, the branched structure allows suppressing the formation of fascicular bundles (aggregates) and thus allows for uniform dispersion in which conductive paths between pieces of fibrous carbon are maintained.

When the fiber diameter of the co-continuous fibrous carbon is excessively small, the fibers become finely cut in the below-described pulverization step (step S5), and thus the co-continuous fibrous carbon undergoes aggregation in the mixing step (step S6) described below. When the fiber diameter is too large, dispersibility drops, and the desired conductivity fails to be obtained, at the time of coating of a lithium oxide with the co-continuous fibrous carbon. Therefore, the fiber diameter is preferably from 10 nm to 200 nm.

Similarly, when the fiber length of the co-continuous fibrous carbon is too small, the co-continuous fibrous carbon undergoes aggregation in the mixing step (step S6) described below, and when the fiber length is excessively large, dispersibility decreases, and the desired conductivity fails to be obtained, at the time of coating of a lithium oxide with the co-continuous fibrous carbon. Therefore, the fiber length is preferably from 300 nm to 2 μm.

The fiber length described in the present embodiment is defined as the average value of length measured through tracing from a given branched portion up to the next branched portion (between adjacent branched portions), in a SEM observation of the co-continuous fibrous carbon. The number of measurement sites is set herein to 500 or more.

In order to produce co-continuous fibrous carbon having a fiber diameter from 10 nm to 200 nm and a fiber length from 300 nm to 2 μm, the cellulose nanofibers that are used have preferably a fiber diameter from 20 nm to 400 nm and a fiber length from 500 nm to 4 μm.

Normally, cellulose nanofibers become thinner and shorter in the carbonization step (step 4), as compared with the cellulose nanofibers prior to carbonization, for instance on account of decomposition, combustion or activation. In a case however where cellulose nanofibers having a fiber diameter smaller than 20 nm are used, the fibers aggregate in the freezing step (step S2), and dry cellulose nanofibers of large fiber diameter can be obtained in the subsequent drying step (step S3). Therefore, the fiber diameter of the obtained co-continuous fibrous carbon is larger than 200 nm when using cellulose nanofibers having a fiber diameter smaller than 20 nm.

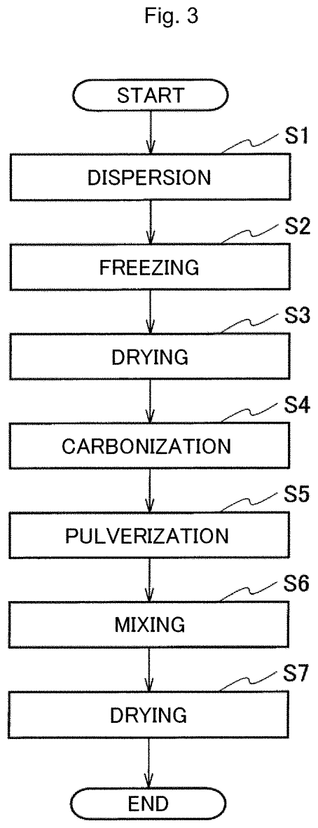

FIG. 3 is a flowchart illustrating a method for producing a carbon-coated lithium oxide that is coated with the co-continuous fibrous carbon of the present embodiment. The carbon-coated lithium oxide contains co-continuous fibrous carbon having a three-dimensional network structure in which carbon is branched.

The production method illustrated in FIG. 3 further includes a pulverization step (step S5), a mixing step (step S6), and a drying step (step S7) in the production method (steps S1-S4) illustrated in FIG. 1. That is, in the carbon-coated lithium oxide of the present embodiment the process of steps S5-S7 is added to the co-continuous fibrous carbon produced in steps S1-S4.

In the pulverization step the co-continuous fibrous carbon having been carbonized in the carbonization step (step S4) described above is pulverized (step S5). In the pulverization step the co-continuous fibrous carbon is made into a powder or slurry using for instance a mixer, a homogenizer, an ultrasonic homogenizer, a high-speed rotary shear-type stirrer, a colloid mill, a roll mill, a high-pressure injection disperser, a rotary ball mill, a vibratory ball mill, a planetary ball mill, an attritor or the like.

In this case, the co-continuous fibrous carbon preferably has a secondary particle size from 10 nm to 1 mm, more preferably from 1 μm to 50 μm. That is because in the case of pulverization to a secondary particle size smaller than 10 nm, the co-continuous structure breaks down and it becomes difficult to obtain sufficient conductive paths. When the secondary particle size is excessively small, the co-continuous fibrous carbon forms bundles by aggregating in a fascicular fashion, which precludes uniform coating of the lithium oxide. In a case where the secondary particle size exceeds 1 mm, the co-continuous fibrous carbon does not form bundles, but the co-continuous fibrous carbon functioning as a conductive filler does not disperse sufficiently in a lithium oxide powder, and it is difficult to maintain the desired conductivity after printing.

A production method using a planetary ball mill allows particle size to be controlled, and is therefore a preferable method. In the present embodiment co-continuous fibrous carbon and zirconia beads of 1 mm or less were placed in a container (jar) of a planetary ball mill, and the co-continuous fibrous carbon was pulverized by causing the container to rotate and revolve. The speed ratio was set to 1:−2. When the revolution speed exceeds 500 rpm at this time, pulverization of the co-continuous fibrous carbon is excessive, and the secondary particle size becomes smaller than 10 nm, which is undesirable. When the revolution speed is lower than 100 rpm, the co-continuous fibrous carbon cannot be pulverized.

In the present embodiment, operations were carried out in a nitrogen atmosphere, but any inert gas may be utilized, for instance argon or helium. Although similar effects can be achieved in air, some of the carbon chemically reacts with oxygen during the process, giving rise to carbon dioxide, which accordingly translates into a lower yield.

The co-continuous fibrous carbon exhibits moreover higher porosity and lower density. In a case where the co-continuous fibrous carbon is pulverized alone, therefore, the powder of the co-continuous fibrous carbon flutters during or after pulverization, and becomes thus difficult to handle. It is accordingly preferable to pulverize the co-continuous fibrous carbon after impregnation with a solvent.

The solvent used herein is not particularly limited, but an organic solvent may be utilized. For instance the solvent includes at least one type selected from the group consisting of 3-methyl-3-methoxybutyl ether, 3-methyl-3-methoxybutanol, n-butanol, n-butylamine, n-methylpyrrolidone, acetone, isoamyl alcohol, isobutanol, isopropanol, ethanol, ethyl carbitol, ethylene glycol, ethylene glycol ethyl ether acetate, ethylene glycol butyl ether, octanol, carboxylic acids, diethylene glycol methyl ether, dipropylene glycol isopropylethyl ether, dipropylene glycol isopropylmethyl ether, dipropylene glycol ethyl ether, dipropylene glycol methyl ether, dodecane, tripropylene glycol methyl ether, propanol, propylene glycol ethyl ether acetate, propylene monomethyl ether, hexadecane, heptane, methanol, butyl acetate, butyl lactate, unsaturated fatty acids and glycerin. The solvent may be made up of at least one type selected from the above group.

In the mixing step, the co-continuous fibrous carbon pulverized in the pulverization step (step S5) and the lithium oxide are mixed, to yield a carbon-coated lithium oxide that is coated with the co-continuous fibrous carbon (step S6).

A solvent may be added in this step. The solvent is not particularly limited, and may include at least one type selected from the group consisting of organic solvents such as 3-methyl-3-methoxybutyl ether, 3-methyl-3-methoxybutanol, n-butanol, n-butylamine, n-methylpyrrolidone, acetone, isoamyl alcohol, isobutanol, isopropanol, ethanol, ethyl carbitol, ethylene glycol, ethylene glycol ethyl ether acetate, ethylene glycol butyl ether, octanol, carboxylic acids, diethylene glycol methyl ether, dipropylene glycol isopropylethyl ether, dipropylene glycol isopropylmethyl ether, dipropylene glycol ethyl ether, dipropylene glycol methyl ether, dodecane, tripropylene glycol methyl ether, propanol, propylene glycol ethyl ether acetate, propylene monomethyl ether, hexadecane, heptane, methanol, acetic acid butyl acetate, butyl lactate, unsaturated fatty acids or glycerin, and aqueous solvents such as water. The solvent may be made up of at least one type selected from the above group.

In the mixing step there can be used for instance a mixer, a homogenizer, an ultrasonic homogenizer, a high-speed rotary shear-type stirrer, a colloid mill, a roll mill, a high-pressure injection disperser, a rotary ball mill, a vibratory ball mill, a planetary ball mill, an attritor, a kneader or the like.

A production method in which a planetary ball mill is utilized allows controlling particle size, and accordingly is a preferred production method. The speed ratio was set to 1:−2. When the revolution speed exceeds 500 rpm at this time, carbon pulverization is excessive, and the secondary particle size becomes smaller than 10 nm, which is undesirable. When the revolution speed is lower than 100 rpm, carbon cannot be pulverized.

A production method has been illustrated in which the mixing step (step S6) is carried out after the pulverization step (step S5), but in a case where a planetary ball mill is utilized, it is also possible to omit the pulverization step (step S5), since in that case the pulverization step (step S5) and the mixing step (step S6) can be carried out simultaneously.

In the drying step, the carbon-coated lithium oxide that is coated with the co-continuous fibrous carbon and that contains a solvent is dried in for instance a thermostatic bath, a dryer or through natural drying, to thereby remove the solvent, and yield a carbon-coated lithium oxide that is coated with the co-continuous fibrous carbon (step S7). The drying temperature is not particularly limited so long as the solvent can be removed, but the drying time can be shortened through heating at a temperature not higher than the boiling point, the flash point or the ignition point of the solvent that is used.

As described above, the carbon-coated lithium oxide of the present embodiment is a lithium oxide coated with carbon, such that the carbon contains co-continuous fibrous carbon having a three-dimensional network structure in which carbon is branched.

The method for producing a carbon-coated lithium oxide of the present embodiment includes a pulverization step of pulverizing co-continuous fibrous carbon having a three-dimensional network structure in which carbon is branched, and a mixing step of mixing the pulverized co-continuous fibrous carbon and lithium oxide.

The present embodiment allows providing a carbon-coated lithium oxide of high conductivity, and a production method thereof.

### Evaluation of the Embodiment

For the purpose of checking the effect of the carbon-coated lithium oxide of the present embodiment, an experiment was conducted in which co-continuous fibrous carbon and lithium oxide were mixed, and the resistance of resulting mixture pellets was measured. Herein Li₂CoPO₄F, which is a polyanionic positive electrode active material, was used as the lithium oxide.

(Production of Co-Continuous Fibrous Carbon)

An explanation follows next on a method for producing the co-continuous fibrous carbon used in the examples and comparative examples described below. Cellulose nanofibers having an average fiber diameter of 40 nm and an average fiber length of 1 μm were used herein. A cellulose nanofiber dispersion was prepared through stirring of 1 g of the cellulose nanofibers and 10 g of ultrapure water in a homogenizer (by SMT Co., Ltd.) for 12 hours, and the dispersion was poured into a test tube.

The cellulose nanofiber dispersion was completely frozen through immersion of the test tube in liquid nitrogen for 30 minutes. After complete freezing of the cellulose nanofiber dispersion, the frozen cellulose nanofiber dispersion was retrieved onto a Petri dish and was dried in vacuum of 10 Pa or less using a freeze dryer (by Tokyo Rikakikai Co., Ltd.) for 24 hours, to yield dry cellulose nanofibers. After drying in vacuum, the dry product was fired in a nitrogen atmosphere at 600° C. for 2 hours, to carbonize as a result the cellulose nanofibers and produce thereby co-continuous fibrous carbon. The co-continuous fibrous carbon was observed by SEM, which revealed that the average fiber diameter was 20 nm and the average fiber length was 500 nm.

### Example 1

In the present example, the co-continuous fibrous carbon and lithium oxide (Li₂CoPO₄F) described above were pulverized and mixed at a revolution speed of a planetary ball mill set to 50 rpm, and were dried, to produce a positive electrode active material. The pulverization/mixing step was carried out in a nitrogen atmosphere, relying on a wet method with mixing of ethanol. In the present example the pulverization step and the mixing step were performed simultaneously.

In the pulverization/mixing step, zirconia balls having a diameter of 2 mm and zirconia balls having a diameter of 1 mm were charged, at a ratio of 1:1, into a planetary ball mill (model number: PM100) by Retsch GmbH, and the above co-continuous fibrous carbon and Li₂CoPO₄F which is a polyanionic positive electrode active material were inputted, at a proportion of 10:90, with further input of ethanol which is an organic solvent. Pulverization and mixing were carried out by causing the planetary ball mill to rotate.

Pulverization was performed for 1 hour, with the speed ratio of the planetary ball mill set to 1:−2, and the revolution speed set to 50 rpm. The zirconia balls were separated by sifting. The co-continuous fibrous carbon was not pulverized and remained on the sieve. The sifted lithium oxide was air-dried in the atmosphere, to thereby evaporate the ethanol. The lithium oxide powder was placed in an oven at 60 degrees, and was dried for 24 hours.

### Example 2

In the present example, the co-continuous fibrous carbon and lithium oxide (Li₂CoPO₄F) described above were pulverized and mixed at a revolution speed of a planetary ball mill set to 100 rpm, and were dried, to produce a positive electrode active material. A pulverization/mixing step was carried out in a nitrogen atmosphere, relying on a wet method with mixing of ethanol. In the present example, a pulverization step and a mixing step were performed simultaneously.

In the pulverization/mixing step, zirconia balls having a diameter of 2 mm and zirconia balls having a diameter of 1 mm were charged, at a ratio of 1:1, into a planetary ball mill (model number: PM100) by Retsch GmbH, and the above co-continuous fibrous carbon and Li₂CoPO₄F which is a polyanionic positive electrode active material were inputted, at a proportion of 10:90, with further input of ethanol which is an organic solvent. Pulverization and mixing were carried out by causing the planetary ball mill to rotate.

Pulverization was performed for 1 hour, with the speed ratio of the planetary ball mill set to 1:−2, and the revolution speed set to 100 rpm. After separation of the zirconia balls and the carbon-coated lithium oxide by sifting, the carbon-coated lithium oxide was air-dried in the atmosphere, to thereby evaporate the ethanol. The carbon-coated lithium oxide powder was placed in an oven at 60 degrees, and was dried for 24 hours.

### Example 3

In the present example, the co-continuous fibrous carbon and lithium oxide (Li₂CoPO₄F) described above were pulverized and mixed at a revolution speed of a planetary ball mill set to 300 rpm, and were dried, to produce a positive electrode active material. A pulverization/mixing step was carried out in a nitrogen atmosphere, relying on a wet method with mixing of ethanol. In the present example, a pulverization step and a mixing step were performed simultaneously.

In the pulverization/mixing step, zirconia balls having a diameter of 2 mm and zirconia balls having a diameter of 1 mm were charged, at a ratio of 1:1, into a planetary ball mill (model number: PM100) by Retsch GmbH, and the above co-continuous fibrous carbon and Li₂CoPO₄F which is a polyanionic positive electrode active material were inputted, at a proportion of 10:90, with further input of ethanol which is an organic solvent. Pulverization and mixing were carried out by causing the planetary ball mill to rotate.

Pulverization was performed for 1 hour, with the speed ratio of the planetary ball mill set to 1:−2, and the revolution speed set to 300 rpm. After separation of the zirconia balls and the carbon-coated lithium oxide by sifting, the carbon-coated lithium oxide was air-dried in the atmosphere, to thereby evaporate the ethanol. The carbon-coated lithium oxide powder was placed in an oven at 60 degrees and was dried for 24 hours.

### Example 4

In the present example, the co-continuous fibrous carbon and lithium oxide (Li₂CoPO₄F) described above were pulverized and mixed at a revolution speed of a planetary ball mill set to 500 rpm, and were dried, to produce a positive electrode active material. A pulverization/mixing step was carried out in a nitrogen atmosphere, relying on a wet method with mixing of ethanol. In the present example, a pulverization step and a mixing step were performed simultaneously.

In the pulverization/mixing step, zirconia balls having a diameter of 2 mm and zirconia balls having a diameter of 1 mm were charged, at a ratio of 1:1, into a planetary ball mill (model number: PM100) by Retsch GmbH, and the above co-continuous fibrous carbon and Li₂CoPO₄F which is a polyanionic positive electrode active material were inputted, at a proportion of 10:90, with further input of ethanol which is an organic solvent. Pulverization and mixing were carried out by causing the planetary ball mill to rotate.

Pulverization was performed for 1 hour, with the speed ratio of the planetary ball mill set to 1:−2, and the revolution speed set to 500 rpm. After separation of the zirconia balls and the carbon-coated lithium oxide by sifting, the carbon-coated lithium oxide was air-dried in the atmosphere, to thereby evaporate the ethanol. The carbon-coated lithium oxide powder was placed in an oven at 60 degrees and was dried for 24 hours.

### Example 5

In the present example, the co-continuous fibrous carbon and lithium oxide (Li₂CoPO₄F) described above were pulverized and mixed at a revolution speed of a planetary ball mill set to 500 rpm, and were dried, to produce a positive electrode active material. The pulverization/mixing step was carried out in an air atmosphere, relying on a wet method with mixing of ethanol. In the present example, a pulverization step and a mixing step were performed simultaneously.

In the pulverization/mixing step, zirconia balls having a diameter of 2 mm and zirconia balls having a diameter of 1 mm were charged, at a ratio of 1:1, into a planetary ball mill (model number: PM100) by Retsch GmbH, and the above co-continuous fibrous carbon and Li₂CoPO₄F which is a polyanionic positive electrode active material were inputted, at a proportion of 10:90, with further input of ethanol which is an organic solvent. Pulverization and mixing were carried out by causing the planetary ball mill to rotate.

Pulverization was performed for 1 hour, with the speed ratio of the planetary ball mill set to 1:−2, and the revolution speed set to 500 rpm. After separation of the zirconia balls and the carbon-coated lithium oxide by sifting, the carbon-coated lithium oxide was air-dried in the atmosphere, to thereby evaporate the ethanol. The carbon-coated lithium oxide powder was placed in an oven at 60 degrees and was dried for 24 hours.

### Example 6

In the present example, the co-continuous fibrous carbon and lithium oxide (Li₂CoPO₄F) described above were pulverized and mixed at a revolution speed of a planetary ball mill set to 500 rpm, and were dried, to produce a positive electrode active material. A pulverization/mixing step was carried out in a nitrogen atmosphere, relying on a dry method without mixing of any solvent. In the present example, a pulverization step and a mixing step were performed simultaneously.

In the pulverization/mixing step, zirconia balls having a diameter of 2 mm and zirconia balls having a diameter of 1 mm were charged, at a ratio of 1:1, into a planetary ball mill (model number: PM100) by Retsch GmbH, and the above co-continuous fibrous carbon and Li₂CoPO₄F which is a polyanionic positive electrode active material were inputted, at a proportion of 10:90. Pulverization and mixing were carried out by causing the planetary ball mill to rotate.

Pulverization was performed for 1 hour, with the speed ratio of the planetary ball mill set to 1:−2, and the revolution speed set to 500 rpm. The zirconia balls and the carbon-coated lithium oxide were separated by sifting.

### Example 7

In the present example, the co-continuous fibrous carbon and lithium oxide (Li₂CoPO₄F) described above were pulverized and mixed at a revolution speed of a planetary ball mill set to 600 rpm, and were dried, to produce a positive electrode active material. A pulverization/mixing step was carried out in a nitrogen atmosphere, relying on a wet method with mixing of ethanol. In the present example, a pulverization step and a mixing step were performed simultaneously.

In the pulverization/mixing step, zirconia balls having a diameter of 2 mm and zirconia balls having a diameter of 1 mm were charged, at a ratio of 1:1, into a planetary ball mill (model number: PM100) by Retsch GmbH, and the above co-continuous fibrous carbon and Li₂CoPO₄F which is a polyanionic positive electrode active material were inputted, at a proportion of 10:90, with further input of ethanol which is an organic solvent. Pulverization and mixing were carried out by causing the planetary ball mill to rotate.

Pulverization was performed for 1 hour, with the speed ratio of the planetary ball mill set to 1:−2, and the revolution speed set to 600 rpm. After separation of the zirconia balls and the carbon-coated lithium oxide by sifting, the carbon-coated lithium oxide was air-dried in the atmosphere, to thereby evaporate the ethanol. The carbon-coated lithium oxide powder was placed in an oven at 60 degrees and was dried for 24 hours.

### Comparative Example 1

In Comparative example 1 an instance will be explained next where co-continuous fibrous carbon is not used. In the present comparative example, Ketjen black and lithium oxide (Li₂CoPO₄F) were pulverized and mixed at a revolution speed of a planetary ball mill set to 500 rpm, and were dried, to produce a positive electrode active material. A pulverization/mixing step was carried out in a nitrogen atmosphere, relying on a wet method with mixing of ethanol. In the present comparative example, the pulverization step and the mixing step were performed simultaneously.

In the pulverization/mixing step, zirconia balls having a diameter of 2 mm and zirconia balls having a diameter of 1 mm were charged, at a ratio of 1:1, into a planetary ball mill (model number: PM100) by Retsch GmbH, and Ketjen black and Li₂CoPO₄F which is a polyanionic positive electrode active material were inputted, at a proportion of 10:90, with further input of ethanol which is an organic solvent. Pulverization and mixing were carried out by causing the planetary ball mill to rotate.

Pulverization was performed for 1 hour, with the speed ratio of the planetary ball mill set to 1:−2, and the revolution speed set to 500 rpm. After sifting to separate the zirconia balls and the lithium oxide coated with carbon, the lithium oxide was air-dried in the atmosphere, to thereby evaporate the ethanol. Further, the lithium oxide powder coated with carbon was placed in an oven at 60 degrees and was dried for 24 hours.

### Comparative Example 2

In Comparative example 2 no carbon was used, and only lithium oxide (Li₂CoPO₄F) was pulverized at a revolution speed of a planetary ball mill set to 500 rpm, and was dried, to produce a positive electrode active material. The pulverization step was carried out in a nitrogen atmosphere, relying on a wet method with mixing of ethanol.

In the pulverization step, zirconia balls having a diameter of 2 mm and zirconia balls having a diameter of 1 mm were charged, at a ratio of 1:1, into a planetary ball mill (model number: PM100) by Retsch GmbH, Li₂CoPO₄F which is a non-polyanionic positive electrode active material was inputted, and ethanol which is an organic solvent was also inputted. The lithium oxide was pulverized by causing the planetary ball mill to rotate.

Pulverization was performed for 1 hour, with the speed ratio of the planetary ball mill set to 1:−2, and the revolution speed set to 500 rpm. After sifting to separate the zirconia balls and the lithium oxide, the lithium oxide was air-dried in the atmosphere, to thereby evaporate the ethanol. The lithium oxide powder was placed in an oven at 60 degrees, and was dried for 24 hours.

(Evaluation Method)

The lithium oxide powders produced in the examples and comparative examples were each placed in a φ20 container, and were pressed at 0.5 kN, to produce pellets the resistivity of which was measured. The dash “-” in the resistivity of Experimental example 1 and Comparative example 2 indicates that the measurement was not possible (10⁷Ω or higher).

TABLE 1

| | | | | | Resis- |
|---|---|---|---|---|---|
| | Speed | | Dispersion | Atmo- | tivity |
| | (rpm) | Carbon type | method | sphere | (Ω) |
| Example 1 | 50 | Co-continuous | Wet | Nitrogen | — |
| | | fibrous carbon | | | |
| Example 2 | 100 | Co-continuous | Wet | Nitrogen | 2 |
| | | fibrous carbon | | | |
| Example 3 | 300 | Co-continuous | Wet | Nitrogen | 1 |
| | | fibrous carbon | | | |
| Example 4 | 500 | Co-continuous | Wet | Nitrogen | 1 |
| | | fibrous carbon | | | |
| Example 5 | 500 | Co-continuous | Wet | Air | 3 |
| | | fibrous carbon | | | |
| Example 6 | 500 | Co-continuous | Dry | Nitrogen | 5 |
| | | fibrous carbon | | | |
| Example 7 | 600 | Co-continuous | Wet | Nitrogen | 40 |
| | | fibrous carbon | | | |
| Comparative | 500 | Amorphous | Wet | Nitrogen | 10 |
| example 1 | | carbon | | | |
| Comparative | 500 | None | Wet | Nitrogen | — |
| example 2 | | | | | |

As illustrated in Table 1, it was confirmed that the resistivity in Examples 2-7 was lower than the resistivity in Example 1, where the co-continuous fibrous carbon was not pulverized and there was no coating with carbon. Accordingly, the lithium oxide that is coated with the co-continuous fibrous carbon of the present embodiment exhibits higher conductivity and higher energy density than the lithium oxide not coated with co-continuous fibrous carbon (Example 1), and thus allows realizing a lithium battery of higher conductivity and higher energy density.

The resistivity in Example 5 was higher than that of Example 4. This is ostensibly because pulverization of the co-continuous fibrous carbon in the atmosphere results in for instance oxidation of the carbon surface, which in turn precludes sufficient formation of conductive paths.

The resistivity in Example 6 was higher than in Example 4. It is deemed that in a dry type, pulverization of the co-continuous fibrous carbon is non-uniform, and sufficient formation of conductive paths cannot be achieved.

The resistivity in Example 7 was higher than in Example 4. It is deemed that due to the high revolution speed of the planetary ball mill, the co-continuous structure breaks down in the pulverized co-continuous fibrous carbon, which translates into insufficient formation of conductive paths.

Comparative example 1 is a carbon-coated lithium oxide in which amorphous carbon is utilized, and has a resistivity of 10. Amorphous carbon does not have a co-continuous structure. For this reason it is difficult to form sufficient conductive paths.

Comparative example 2 is a lithium oxide not coated with carbon, and in which resistivity exceeded the measurement range. It is deemed that it is difficult to achieve sufficient conduction in lithium oxide due to the absence of conductive paths in the Comparative example 2.

The present invention is not limited to the above embodiments, and can accommodate various modifications and combinations within the technical idea of the invention.

### REFERENCE SIGNS LIST

S1 Dispersion step
S2 Freezing step
S3 Drying step
S4 Carbonization step
S5 Pulverization step
S6 Mixing step
S7 Drying step

1. A carbon-coated lithium oxide, being a lithium oxide coated with carbon, wherein said carbon contains co-continuous fibrous carbon having a three-dimensional network structure in which carbon is branched.

2. The carbon-coated lithium oxide of claim 1, wherein said co-continuous fibrous carbon has a fiber diameter from 10 nm to 200 nm, a fiber length from 300 nm to 2 μm, and a secondary particle size from 1 μm to 50 μm.

3. A method for producing a carbon-coated lithium oxide, the method comprising:
a pulverization step of pulverizing co-continuous fibrous carbon having a three-dimensional network structure in which carbon is branched; and
a mixing step of mixing said pulverized co-continuous fibrous carbon and a lithium oxide.

4. The method for producing a carbon-coated lithium oxide of claim 3, wherein in said pulverization step a planetary ball mill is used, and a revolution speed of said planetary ball mill lies in the range from 100 rpm to 500 rpm.

5. The method for producing a carbon-coated lithium oxide of claim 3, wherein said mixing step includes:
a first step of obtaining a mixture by mixing said pulverized co-continuous fibrous carbon, said lithium oxide, and an organic solvent; and
a second step of removing the solvent in said mixture, to obtain a lithium oxide coated with carbon.

6. The method for producing a carbon-coated lithium oxide of claim 3, wherein said pulverization step and said mixing step are carried out in an inert gas.

7. The method for producing a carbon-coated lithium oxide of claim 4, wherein said mixing step includes:
a first step of obtaining a mixture by mixing said pulverized co-continuous fibrous carbon, said lithium oxide, and an organic solvent; and
a second step of removing the solvent in said mixture, to obtain a lithium oxide coated with carbon.

8. The method for producing a carbon-coated lithium oxide of claim 4, wherein said pulverization step and said mixing step are carried out in an inert gas.

9. The method for producing a carbon-coated lithium oxide of claim 5, wherein said pulverization step and said mixing step are carried out in an inert gas.
